(19) United States
(12) Patent Application Publication
(10) Pub. No.: US 2014/0084562 A1
(43) Pub. Date: Mar. 27, 2014

(54) WHEELCHAIR TRANSIT BRACKET ASSEMBLY

(71) Applicant: Sunrise Medical (US), LLC., Fresno, CA (US)

(72) Inventors: Benjamin A. Anooshian, Fresno, CA (US); Samuel D. Traxinger, Fresno, CA (US); Jason Shelton, Fresno, CA (US); Thomas Lockton, Clovis, CA (US)

(73) Assignee: SUNRISE MEDICAL (US), LLC, Fresno, CA (US)

(21) Appl. No.: 14/027,977

(22) Filed: Sep. 16, 2013

Related U.S. Application Data
(60) Provisional application No. 61/706,380, filed on Sep. 27, 2012.

(51) Int. Cl. A61G 3/08; A61G 5/10

(52) U.S. Cl. CPC A61G 3/0808; A61G 5/10
USPC 280/250.1; 296/65.04

(57) ABSTRACT

A wheelchair transit bracket assembly is provided and includes a clamp configured for attachment to a portion of a wheelchair frame. A pivot is attached to the clamp and is configured for rotation relative to the clamp. The pivot is configured for attachment to a tie-down assembly. The tie-down assembly is configured to secure the wheelchair to a vehicle during transit. A belt bracket is attached to the pivot and is configured for rotation relative to the pivot. The belt bracket is configured for attachment to a lap belt thereby forming a lap belt assembly. The lap belt assembly is configured to secure an occupant to the wheelchair during transit. In an installed position, the wheelchair transit bracket assembly is configured to transfer forces generated by the wheelchair and wheelchair occupant from the lap belt assembly to the tie-down assembly without introducing the forces to the wheelchair frame.

### CROSS-REFERENCE TO RELATED APPLICATIONS

This application claims the benefit of U.S. Provisional Application No. 61/706,380, filed Sep. 27, 2012, the disclosure of which is incorporated herein by reference.

### BACKGROUND

People with disabilities often use wheelchairs for mobility. Some people are unable to transfer from their wheelchair to a vehicle seat when traveling in motor vehicles. In those situations, the wheelchair serves as the vehicle seat.

It is known to retrofit motor vehicles with after-market equipment to secure wheelchairs to the motor vehicle, using structures and mechanisms commonly referred to as tie-down straps. It is also known to provide structures and mechanisms to restrain an occupant to the secured wheelchair in the event of severe braking of the motor vehicle or an accident.

In certain instances, the occupant restraint structures and the structures to secure the wheelchair to the vehicle can introduce undesired forces and loads to the wheelchair frame and other wheelchair structural components.

It would be advantageous if the occupant restraint structures and the structures securing the wheelchair to the vehicle could be improved.

### SUMMARY OF THE INVENTION

According to this invention there is provided a wheelchair transit bracket assembly including a clamp configured for attachment to a portion of a wheelchair frame. A pivot is attached to the clamp. The pivot is configured for rotation relative to the clamp. The pivot is further configured for attachment to a tie-down assembly. The tie-down assembly is configured to secure the wheelchair to a vehicle during transit. A belt bracket is attached to the pivot. The belt bracket is configured for rotation relative to the pivot. The belt bracket is further configured for attachment to a lap belt thereby forming a lap belt assembly. The lap belt assembly is configured to secure an occupant to the wheelchair during transit. In an installed position, the wheelchair transit bracket assembly is configured to transfer loads and forces generated by the wheelchair and wheelchair occupant from the lap belt assembly to the tie-down assembly without substantially introducing the loads and the forces to the wheelchair frame.

According to this invention, there is also provided a wheelchair transit bracket assembly including a loop configured for attachment to a portion of a wheelchair frame. A portion of the loop is configured for attachment to a tie-down assembly. The tie-down assembly is configured to secure the wheelchair to a vehicle during transit. A pivot attachment is attached to the loop and configured for slidable movement along the loop. A belt bracket is attached to the pivot attachment and configured for rotation relative to the pivot attachment. The belt bracket is further configured for attachment to a lap belt thereby forming a lap belt assembly. The lap belt assembly is configured to secure an occupant to the wheelchair during transit. In an installed position, the wheelchair transit bracket assembly is configured to transfer loads and forces generated by the wheelchair and wheelchair occupant from the lap belt assembly to the tie-down assembly without substantially introducing the loads and the forces to the wheelchair frame.

According to this invention, there is also provided a wheelchair transit bracket assembly including a loop mount configured for insertion into a portion of a wheelchair frame and a loop attached to the loop mount. The loop is configured for rotation relative to the loop mount and further configured for attachment to a tie-down assembly. The tie-down assembly is configured to secure the wheelchair to a vehicle during transit. A belt bracket is attached to the loop and configured for rotation relative to the loop. The belt bracket is further configured for attachment to a lap belt thereby forming a lap belt assembly. The lap belt assembly is configured to secure an occupant to the wheelchair during transit. In an installed position, the wheelchair transit bracket assembly is configured to transfer loads and forces generated by the wheelchair and wheelchair occupant from the lap belt assembly to the tie-down assembly without substantially introducing the loads and the forces to the wheelchair frame.

According to this invention, there is also provided a wheelchair transit bracket assembly including a clamp configured for attachment to a portion of a wheelchair frame. A belt bracket is attached to the clamp and configured for rotation relative to the clamp. The belt bracket is also configured for attachment to a lap belt thereby forming a lap belt assembly. The lap belt assembly is configured to secure an occupant to the wheelchair during transit. The belt bracket has a flexible portion and the flexible portion includes a loop. The loop is configured for rotation relative to the belt bracket and further configured for attachment to a tie-down assembly. The tie-down assembly is configured to secure the wheelchair to a vehicle during transit. In an installed position, the wheelchair transit bracket assembly is configured to transfer loads and forces generated by the wheelchair and wheelchair occupant from the lap belt assembly to the tie-down assembly without substantially introducing the loads and the forces to the wheelchair frame.

According to this invention, there is also provided a wheelchair including a frame, a seat attached to the frame, the seat configured to receive an occupant, a plurality of wheels attached to the frame so as to allow the frame to roll, and a plurality of wheelchair transit bracket assemblies connected to portions of the wheelchair frame. Each of the wheelchair transit bracket assemblies has a transit clamp configured for attachment to a portion of a wheelchair frame, and a pivot attached to the transit clamp. The pivot is configured for rotation relative to the clamp and further configured for attachment to a tie-down assembly. The tie-down assembly is configured to secure the wheelchair to a vehicle during transit. A belt bracket is attached to the clamp and configured for rotation relative to the clamp. The belt bracket is further configured for attachment to a lap belt assembly. The lap belt assembly is configured to secure an occupant to the wheelchair during transit. In an installed position, the wheelchair transit bracket assemblies are configured to transfer loads and forces generated by the wheelchair and wheelchair occupant from the lap belt assembly to the tie-down assembly without substantially introducing the loads and the forces to the wheelchair frame.

Various objects and advantages will become apparent to those skilled in the art from the following detailed description of the invention, when read in light of the accompanying drawings. It is to be expressly understood, however, that the drawings are for illustrative purposes and are not to be construed as defining the limits of the invention.

### BRIEF DESCRIPTION OF THE DRAWINGS

FIG. 1 is a perspective view of a first embodiment of a wheelchair transit bracket assembly attached to a wheelchair frame.

FIG. 2 is an exploded perspective view of the wheelchair transit bracket assembly of FIG. 1.

FIG. 3 is a perspective view of a second embodiment of a wheelchair transit bracket assembly attached to a wheelchair frame.

FIG. 4 is an exploded perspective view of the wheelchair transit bracket assembly of FIG. 3.

FIG. 5 is a perspective view of a third embodiment of a wheelchair transit bracket assembly attached to a wheelchair frame.

FIG. 6 is an exploded perspective view of the wheelchair transit bracket assembly of FIG. 5.

FIG. 7 is a perspective view of a fourth embodiment of a wheelchair transit bracket assembly attached to a wheelchair frame.

FIG. 8 is an exploded perspective view of the wheelchair transit bracket assembly of FIG. 7.

FIG. 9 is a perspective view of a fifth embodiment of a wheelchair transit bracket assembly attached to a wheelchair frame.

FIG. 10 is an exploded perspective view of the wheelchair transit bracket assembly of FIG. 9.

FIG. 11 is a perspective view of a sixth embodiment of a wheelchair transit bracket assembly attached to a wheelchair frame.

FIG. 12 is an exploded perspective view of the wheelchair transit bracket assembly of FIG. 11.

### DETAILED DESCRIPTION OF THE INVENTION

The present invention will now be described with reference to the specific embodiments of the invention. This invention may, however, be embodied in different forms and should not be construed as limited to the embodiments set forth herein. Rather, these embodiments are provided so that this disclosure will be thorough and complete and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, a wheelchair transit bracket assembly is provided for attachment to a wheelchair frame. The wheelchair transit bracket assembly provides for connection of the chair mounted lap belt with a plurality of tie-down straps. Generally, the wheelchair transit bracket assembly allows the lap belt to be connected to the tie-down straps such that forces and loads generated by the occupant and the wheelchair during severe braking of the vehicle or an accident are not introduced to the wheelchair frame and other wheelchair structural components. These loads may also arise in the event of a rapid acceleration event. In such an arrangement, the transit bracket assembly may be mounted in an opposite sense from that described with the deceleration events. This directional arrangement maintains the transit bracket assembly in a generally or predominantly tensile condition when transferring loads to the vehicle.

The term “wheelchair”, as used herein, is defined to mean any seating system comprised of a frame, a seat and wheels, that is designed to provide support and mobility for persons seated in the wheelchair. As defined herein, the term “wheelchair” encompasses standard manual wheelchairs, powered wheelchairs, power-based wheelchairs, three wheel scooter-type wheelchairs and specialized seating bases. The term “frame”, as used herein, is defined to mean a skeletal structure forming the general shape of the wheelchair. The term “seat”, as used herein, is defined to mean any structure on which a person sits. The term “tie-down strap”, as used herein, is defined to mean any structure used to secure the wheelchair to a vehicle.

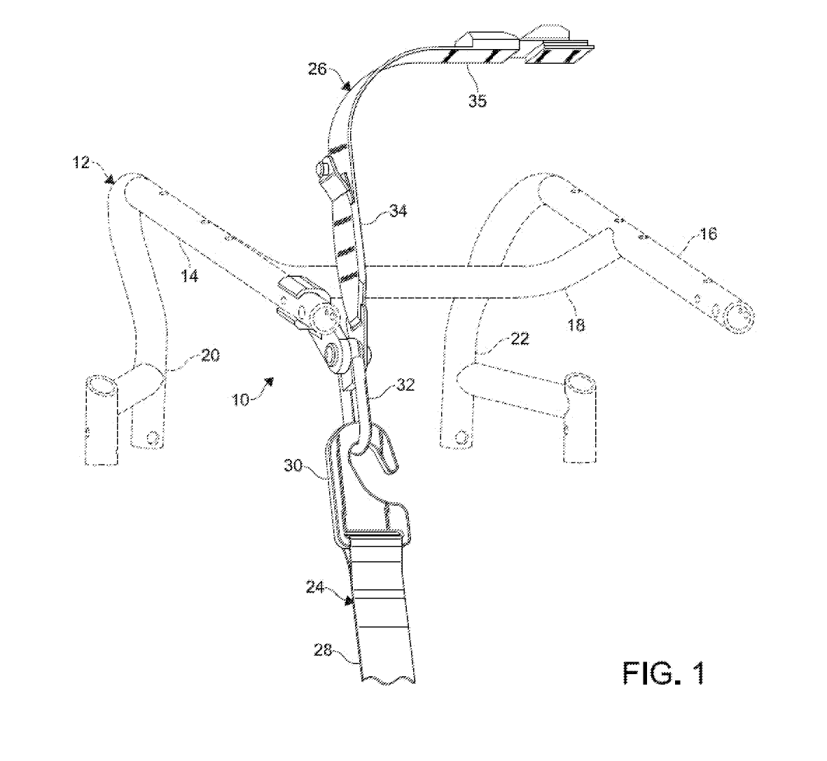

Referring now to FIG. 1, a first embodiment of a wheelchair transit bracket assembly (hereafter “bracket assembly”) is shown generally at 10. The bracket assembly 10 is attached to a wheelchair frame 12 (hereafter “frame”). For purposes of clarity, portions of the frame 12 are illustrated in phantom. The frame 12 includes opposing first and second side tubes 14 and 16 connected together by one or more cross tubes 18. The first and second side tubes 14 and 16 are connected to first and second down tubes 20 and 22, respectively. The first and second side tubes 14 and 16, cross tube 18 and the first and second down tubes 20 and 22 are conventional in the art and may be embodied as any of a variety of well known structures.

Referring again to FIG. 1, the bracket assembly 10 is configured for attachment to a portion of the first side tube 14. For purposes of clarity, only the bracket assembly 10 connected to the first side tube 14 is illustrated. However, it should be appreciated that in practice, another bracket assembly 10 is connected to the second side tube 16.

Generally, the bracket assembly 10 provides an attachment axis through which a tie-down assembly 24 is connected to a lap belt assembly 26. As will be explained in more detail below, having the bracket assembly 10 connected to the tie-down assembly 24, through the attachment axis, provides that forces and loads generated by the occupant and the wheelchair during severe braking of the vehicle or an accident are transmitted to the vehicle and are not substantially introduced to the wheelchair frame and other wheelchair structural components.

Referring again to FIG. 1, the tie-down assembly 24 includes a tie-down strap 28 attached to a connector 30. The end of the tie-down strap 28 that is not attached to the connector 30 is secured to the vehicle (not shown). The connector 30 is configured for attachment to a pivot 32. In the embodiment illustrated in FIG. 1, the tie-down strap 28 is a fabric-based belt and the connector 30 has the form of a hook. However, the tie-down strap 28 and the connector 30 are conventional in the art and may be embodied as any of a variety of well known structures sufficient such that the tie-down strap 28 can be connected to the vehicle and the connector 30 can be attached to the pivot 32.

Referring again to FIG. 1, the lap belt assembly 26 includes a belt bracket 34 connected to a lap belt 35. The end of the lap belt 35 that is not attached to the belt bracket 34 is secured to an opposing lap belt (not shown), which in turn is attached to the bracket assembly (not shown, but the same as or similar to bracket assembly 10) connected to the second side tube 16. The belt bracket 34 is configured for attachment to the pivot 32. In the embodiment illustrated in FIG. 1, the lap belt 35 is a fabric-based belt. However, the lap belt 35 is conventional in the art and may be embodied as any of a variety of well known structures. The belt bracket 34 will be described in more detail below.

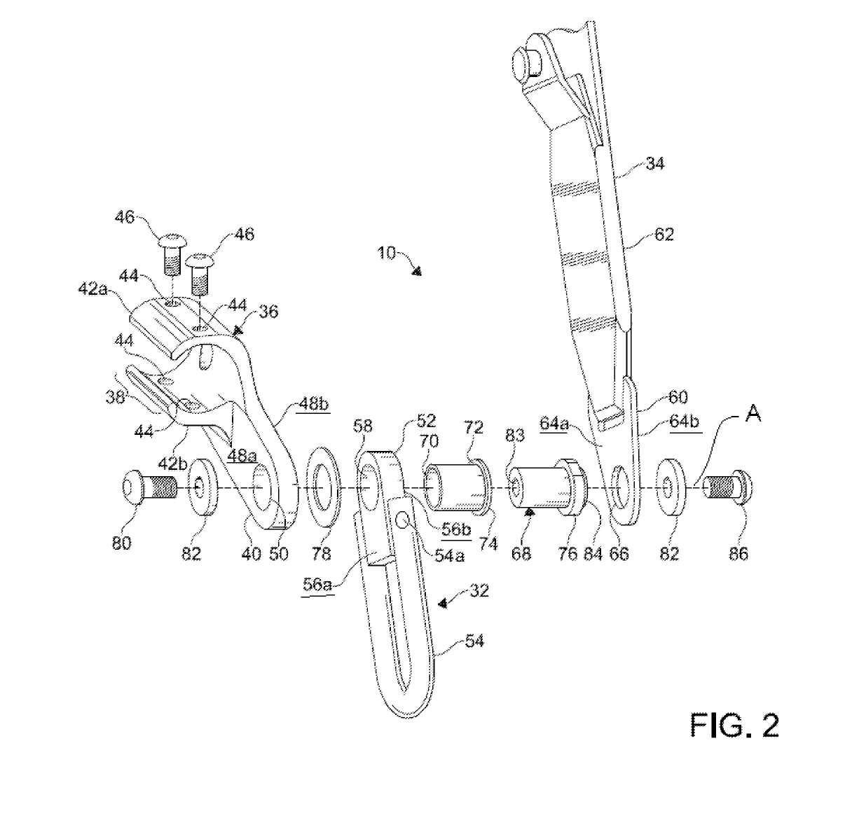

Referring now to FIG. 2, the bracket assembly 10 is shown in an exploded view. The bracket assembly 10 includes a mounting structure in the form of a clamp 36, the pivot 32, the belt bracket 34 and various connecting hardware. The clamp 36 includes a first portion 38 and a second portion 40. The first portion 38 is configured for attachment to the first side tube 14 as shown in FIG. 1. Referring again to FIG. 2, the first portion 38 includes opposing arms 42a and 42b. In the illustrated embodiment, the opposing arms 42a and 42b have arcuate cross-sectional shapes sufficient to approximate the cross-sectional shape of the outer surface of the first side tube 14. However, it should be appreciated that in other embodiments, the opposing arms 42a and 42b can have other cross-sectional shapes.

Referring again to FIG. 2, the arms 42a and 42b each has a plurality of apertures 44. The apertures 44 are configured to receive a plurality of fasteners 46 such that the fasteners 46 secure the clamp 36 to the first side tube 14. In the illustrated embodiment, the fasteners 46 are threaded members, such as for example machine screws. Alternatively, the fasteners 46 can be other structures, such as the non-limiting example of sheet metal screws. In still other embodiments, it is within the contemplation of this invention that the clamp 36 can be attached to the first side tube 14 with other mechanisms, structures, or devices, such as the non-limiting examples of clips or clamps or methods including welding or adhesives. The second portion 40 of the clamp 36 includes a first major surface 48a, a second major surface 48b and an aperture 50 extending therethrough.

Referring again to FIG. 2, the pivot 32 has a first segment 52 and a second segment 54. The first segment 52 includes a first major surface 56a, a second major surface 56b and an aperture 58 extending therethrough. The second segment 54 of the pivot 32 has the form of a looped structure. The looped structure is configured to receive the connector 30 as shown in FIG. 1. While the embodiment of the second segment 54 of the pivot 32 illustrated in FIG. 2 has the form of a looped structure, it should be appreciated that in other embodiments, the second segment 54 of the pivot 32 can have other desired forms sufficient to receive the connector 30. In addition, the second segment 54 may be rigidly or pivotally connected to the first segment. When connected for pivotal movement, the second segment 54 may include a hinge 54a that defines a pivot axis generally perpendicular to common attachment axis, A.

Referring again to FIG. 2, the belt bracket 34 includes a first portion 60 and a second portion 62. The first portion 60 includes a first major surface 64a, a second major surface 64b and an aperture 66 extending therethrough. The second portion 62 is configured for attachment to the lap belt 35 as shown in FIG. 1. The second portion 62 of the transit belt bracket 34 can be attached to the lap belt 35 using any desired mechanisms, devices or structures.

Referring again to FIG. 2, the bracket assembly 10 may be assembled by the following assembly steps. It should be understood that these assembly steps are for illustrative purposes and may be conducted in an order other than specifically recited. First, a pivot bolt or pivot journal 68 is inserted into an aperture 70 of a bushing 72 until a flange 74 of the bushing 72 seats against a flange 76 of the pivot journal 68. The pivot journal 68 has an outer diameter that approximates the inner diameter of the bushing 72 such that the pivot journal 68 seats within the bushing 72.

In the illustrated embodiment, the bushing 72 is formed from a low friction material such as for example bronze. However, in other embodiments, the bushing 72 can formed from other materials including the non-limiting example of reinforced polymers. In still other embodiments, the bushing 72 can include low-friction coatings on the outer surface.

Referring again to FIG. 2 in a next step, the assembled combination of the pivot journal 68 and the bushing 72 are inserted through the aperture 58 in the first segment 52 of the pivot 32 such that the flange 74 of the bushing 72 seats against the second surface 56b of the first segment 52 of the pivot 32. In this assembled position, the bushing 72 extends through the aperture 58 and the pivot 32 is rotatably moveable about the bushing 72. In a next step, a thrust bearing 78 is seated against the first surface 56a of the first segment 52 of the pivot 32. In this assembled position, the bushing 72 extends through the thrust bearing 78. In the illustrated embodiment, the thrust bearing 78 has the form of a metallic flat washer and is configured to allow the pivot 32 to rotate relative to the second portion 40 of the clamp 36. However, it should be appreciated that in other embodiments the thrust bearing 78 can have other forms, including the non-limiting example of rolling element bearings and non-metallic, low friction members.

The assembled combination of the pivot journal 68, bushing 72, pivot 32 and thrust bearing 78 are inserted through the aperture 50 in the second portion 40 of the clamp 36 such that the bushing 72 seats within the aperture 50 and the thrust bearing 78 seats against the second major surface 48b of the second portion 40 of the clamp 36. Once the assembled combination is seated against the second portion 40 of the clamp 36, a first threaded fastener 80 and washer 82 are inserted into a threaded aperture 83 in the pivot journal 68 and tightened so as to fix the assembly together. In an assembled condition, the pivot 32 is rotatably moveable about the bushing 72. In one embodiment, the length of the pivot journal 68 from the flange 76 to the distal end is sufficient to extend completely through the apertures 50 and 58 and thrust bearing 78. While the embodiment shown in FIG. 2 provides that the threaded fastener 80 is used to assemble the various components together, it should be appreciated that in other embodiments, other desired structure, mechanisms and devices can be used to fix the assembly together.

Referring again to FIG. 2 in a next step, the belt bracket 34 is positioned such that the aperture 66 mates with a projection 84 in one end of the pivot journal 68. Next, once the belt bracket 34 mates with the projection 84, a second threaded fastener 86 and washer 82 are inserted into the threaded aperture 83 in the pivot journal 68 and tightened such as to fix the belt bracket 34 to the prior assembly. In an assembled condition, the belt bracket 34 is rotatably moveable about the projection 84. In one embodiment, the length of the projection 84 is slightly longer than the thickness of the first portion 60 of the belt bracket 34. While the embodiment shown in FIG. 2 provides that the threaded fastener 86 is used to assemble the various components together, it should be appreciated that in other embodiments, other desired structure, mechanisms and devices can be used to fix the assembly together.

Referring again to FIG. 1, the assembled bracket assembly 10 is fastened to the first side tube 14 as described above. Once the wheelchair is positioned within the vehicle, the tie-down assembly 24 can be connected to the pivot 32 and the lap belt 35 can be connected to the belt bracket 34.

Referring again to FIG. 1, once the occupant is secured within the wheelchair by the lap belts 26, it should be evident that forces and loads generated by the occupant and the wheelchair during severe braking of the vehicle or an accident are transmitted through the lap belts 26 to the tie-down assemblies 24 and from the tie-down assemblies 24 to the vehicle. The lap belts 26 and the tie-down assemblies are connected together using the bracket assemblies 10. The bracket assemblies form the common attachment axis, A, for the lap belts 26 and the tie-down assemblies 24. The common attachment axis substantially maintains alignment of the lap belts 26 and the tie-down assemblies 24 such that a majority of the impact loads transfer directly from the lap belts 26 to the vehicle mounted tie-down assemblies 24. Accordingly, the resultant forces and loads are not substantially introduced to the wheelchair frame and other wheelchair structural components.

In the embodiment illustrated in FIGS. 1 and 2, the bracket assembly 10 conforms to the standards and requirements of ANSI RESNA WC19. Generally, ANSI RESNA WC19 concerns wheelchairs for use as seats in Motor Vehicles. Specifically, ANSI RESNA WC19 requires that secured wheelchairs do not add to the loads on an occupant during a crash and provide support for the occupant under impact loading and during rebound, thereby controlling occupant kinematics in order to optimize the performance of restraint systems and minimize occupant contact with interior vehicle components.

Since the overall goal of ANSI RESNA WC19 is to provide a level of transport safety equivalent to non-wheelchair users seated in motor vehicles, the basic principles and test procedures in ANSI RESNA WC19 parallel those of the automotive industry. ANSI RESNA WC19 requires, as the core of the performance test, a simulated 30 mph crash test in which a specified load (crash pulse) is applied to the test product. Failure to meet the evaluation criteria means that product cannot be labeled as a wheelchair transport product. The crash test simulates a frontal crash of the vehicle, since side and rear impacts are statistically less likely to occur.

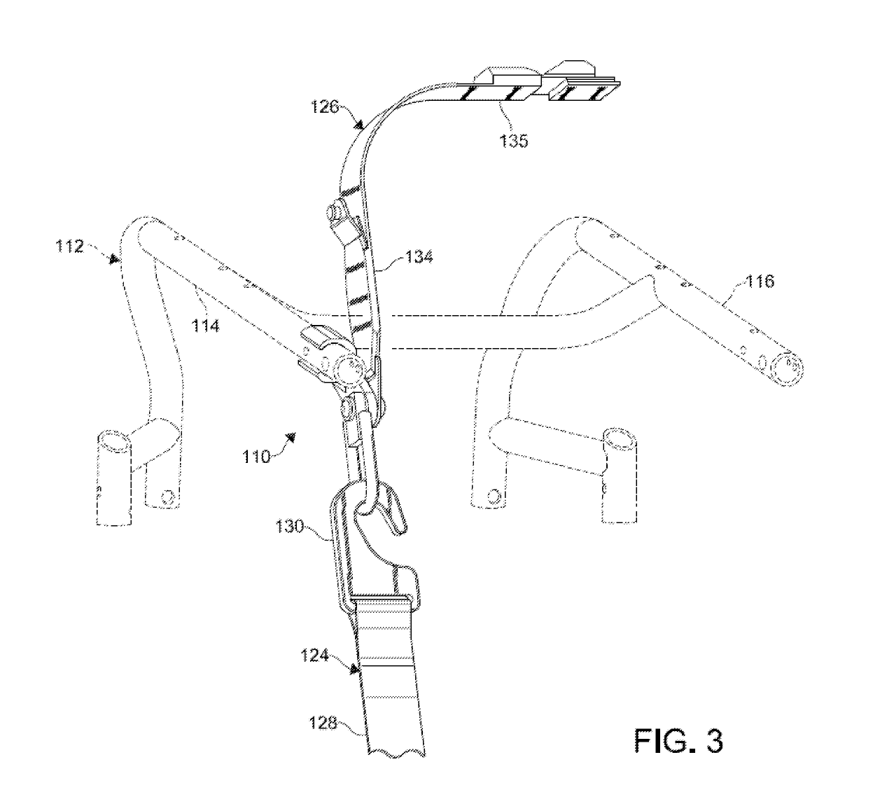

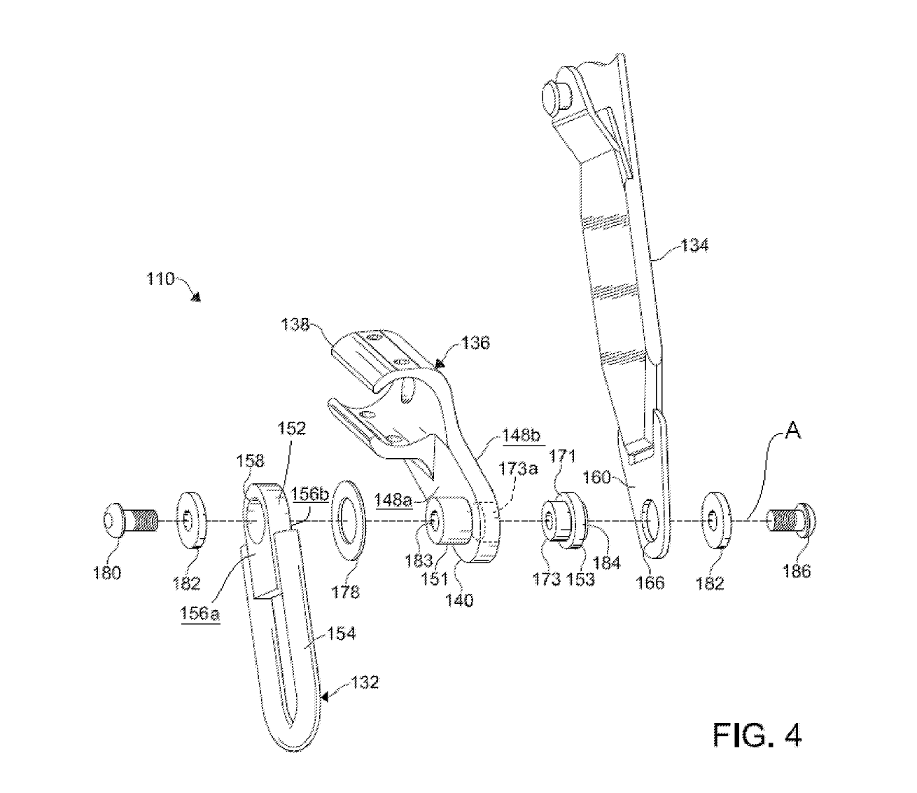

While the embodiment of the bracket assembly 10 shown in FIGS. 1 and 2 illustrate the assembly of the various components in one manner, it should be appreciated that in other embodiments, the components of the bracket assembly can be assembled in other manners while maintaining the common attachment axis. Referring now to FIGS. 3 and 4, a second embodiment of a bracket assembly is shown generally at 110. Generally, the bracket assembly 110 differs from the bracket assembly 10 shown in FIGS. 1 and 2 in that the pivot and the belt bracket are positioned on opposing sides of the clamp rather than on a same side of the clamp.

Referring now to FIG. 3, the bracket assembly 110 is configured for attachment to a portion of a first side tube 114 of a frame 112. For purposes of clarity, only the bracket assembly connected to the first side tube 114 is illustrated. However, it should be appreciated that in practice, another bracket assembly 110 is connected to a second side tube 116. In the illustrated embodiment, the frame 112, including first and second side tubes 114 and 116 are the same as, or similar to, the frame 12 illustrated in FIG. 1 and described above. Alternatively, the frame 112 can be different from the frame 12.

Referring again to FIG. 3, a tie-down assembly 124 includes a tie-down strap 128 attached to a connector 130 and a lap belt assembly 126 includes a belt bracket 134 connected to a lap belt 135. In the illustrated embodiment, the tie-down assembly 124 and lap belt assembly 126 are the same as, or similar to, the tie-down assembly 24 and lap belt assembly 26 illustrated in FIG. 1 and described above. In other embodiments, the tie-down assembly 124 and the lap belt assembly 126 can be different from the tie-down assembly 24 and the lap belt assembly 26.

Referring now to the embodiment illustrated in FIG. 4, a pivot 132, belt bracket 134, thrust bearing 178, first threaded fastener 180, a plurality of washers 182 and a second threaded fastener 186 are the same as, or similar to, the pivot 32, belt bracket 34, thrust bearing 78, first threaded fastener 80, washers 82 and second threaded fastener 86 illustrated in FIG. 1 and described above. However, in other embodiments, the various components shown in FIG. 4 and the components shown in FIG. 1 can be different.

Referring again to FIG. 4, a mounting structure in the form of a clamp 136 includes a first portion 138 and a second portion 140. In the illustrated embodiment, the first portion 138 is the same as, or similar to, the first portion 38 illustrated in FIG. 2 and described above. However, in other embodiments, the first portion 138 can be different from the first portion 38.

Referring again to FIG. 4, the second portion 140 of the clamp 136 includes first and second major surfaces 148a and 148b. The clamp 136 further includes a projection or pivot journal 151 extending from the first major surface 148a. The projection or pivot journal 151 may be fixed to or integrally formed as part of the second portion 140.

Referring again to FIG. 4, the bracket assembly 110 may be assembled by the following assembly steps. As noted previously, the assembly steps are for illustrative purposes and may be conducted in an order other than specifically recited. First, the thrust bearing 178 is seated over the projection 151 and against a first surface 148a of the second segment 140 of the pivot 132. In this position, the projection 151 extends through the thrust bearing 178. The assembled combination of the pivot 132 having the projection 151 and the thrust bearing 178 are inserted through an aperture 158 in a first segment 152 of the pivot 132 such that the projection 151 seats within the aperture 158 and the thrust bearing 178 seats against a second major surface 156b of the first segment 152 of the pivot 132. The pivot 132 further includes a second segment 154, illustrated as a loop similar to second segment 54, though other structures providing the same function may used. The second segment 154 may be fixed or pivotally mounted to the first segment 152 as desired. Once the assembled combination is seated against the first segment 152 of the pivot 132, the first threaded fastener 180 is inserted into a threaded aperture 183 in the projection 151 and washer 182 is seated against a first surface 156a. The first threaded fastener 180 is then tightened so as to fix the assembly together. In an assembled condition, the pivot 132 is rotatably moveable about the projection 151.

Referring again to FIG. 4 in a next step, an adapter 153 is positioned such that a shoulder 171 contacts the second major surface 148b of the clamp 136. In this position, a projection 173 seats within a corresponding recess 173a that is axially aligned and generally concentric with the threaded aperture 183 in the projection 151 of the clamp 136. Next, the belt bracket 134 is positioned such that an aperture 166 in the first portion 160 mates with a projection 184 extending from one end of the adapter 153. Once the belt bracket 134 mates with the projection 184, a second threaded fastener 186 and washer 182 are inserted into the threaded aperture 183 in the projection 151 and tightened so as to fix the belt bracket 134 to the prior assembly. In an assembled condition, the belt bracket 134 is rotatably moveable about the projection 184. While the embodiment shown in FIG. 4 provides that the threaded fastener 186 is used to assemble the various components together, it should be appreciated that in other embodiments, other desired structure, mechanisms and devices can be used to fix the assembly together.

Referring again to FIG. 3, assembled bracket assemblies 110 are fastened to the first and second side tubes 114 and 116 in the same manner as described above. Once the wheelchair is positioned within the vehicle, the tie-down assemblies 124 can be connected to the second segments 154 of the transit pivot 132 and the lap belts 135 can be connected to the transit belt brackets 134.

In operation, the bracket assemblies 110 transfer of the majority of the impact load from the lap belts 126 to the vehicle mounted tie-down assemblies 124 as described above, thereby providing that the forces and loads are not introduced to the wheelchair frame and other wheelchair structural components.

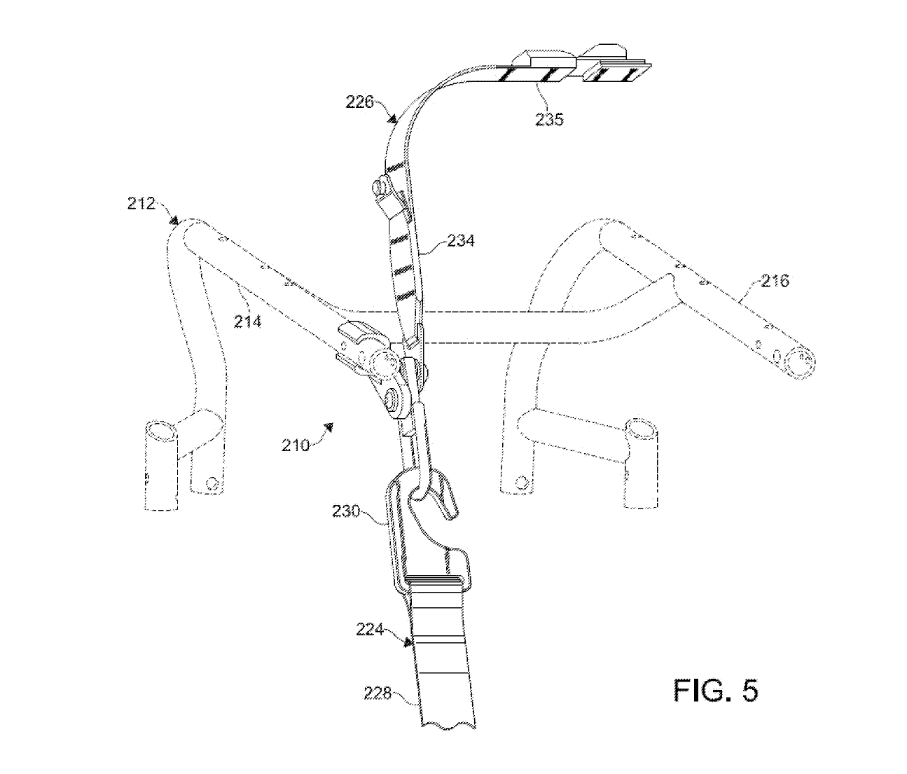

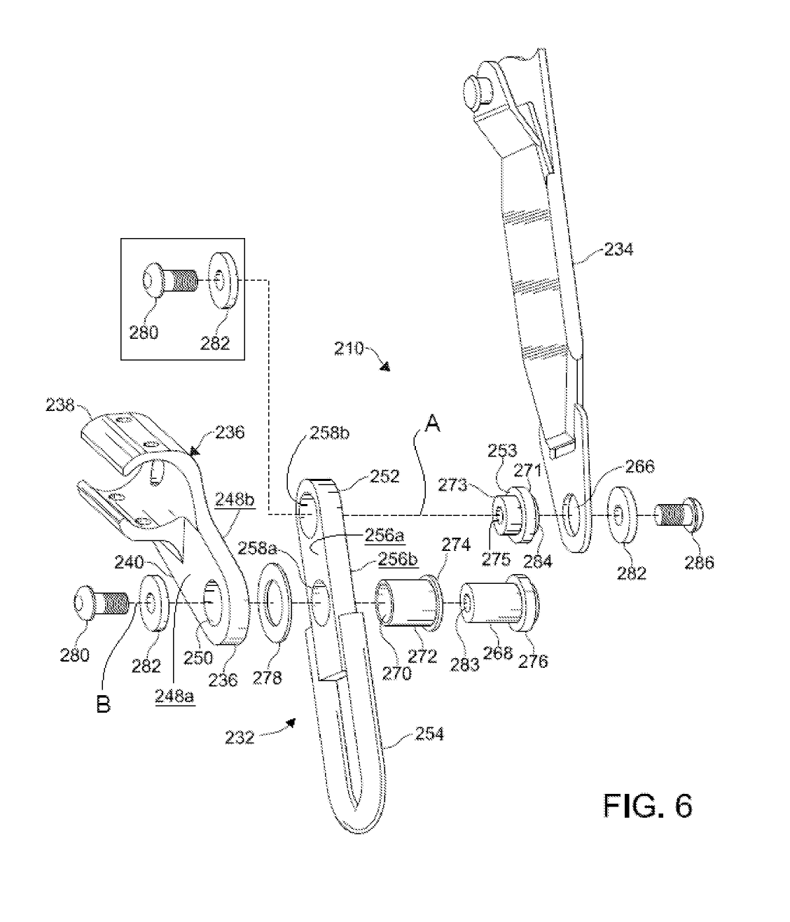

While the embodiments of the bracket assemblies shown in FIGS. 1-4 illustrate the assembly of the various components through the common attachment axis, A, it should be appreciated that in other embodiments, the bracket assemblies can have more than one attachment axis. Referring now to FIGS. 5 and 6, a third embodiment of a bracket assembly is shown generally at 210. Generally, the bracket assembly 210 differs from the bracket assemblies described above in that the pivot now includes two apertures, one for attachment to the clamp and a second for attachment of the belt bracket. Each aperture defines an attachment axis, shown as attachment axes A and B, that are offset from each other.

Referring now to FIG. 5, the bracket assembly 210 is configured for attachment to a portion of a first side tube 214 of a frame 212. For purposes of clarity, only the bracket assembly connected to the first side tube 214 is illustrated. However, it should be appreciated that in practice, another bracket assembly 210 is connected to a second side tube 216. In the illustrated embodiment, the frame 212, including the first and second side tubes 214 and 216, is the same as or similar to the frame 12 illustrated in FIG. 1 and described above. Alternatively, the frame 212 can be different from the frame 12.

Referring again to FIG. 5, a tie-down assembly 224 includes a tie-down strap 228 attached to a connector 230 and a lap belt assembly 226 includes a belt bracket 234 connected to a lap belt 235. In the illustrated embodiment, the tie-down assembly 224 and the lap belt assembly 226 are the same as, or similar to, the tie-down assembly 24 and lap belt assembly 26 illustrated in FIG. 1 and described above. In other embodiments, the tie-down assembly 224 and the lap belt assembly 226 can be different from the tie-down assembly 24 and the lap belt assembly 26.

Referring now to the embodiment illustrated in FIG. 6, a belt bracket 234, clamp 236, pivot bolt or pivot journal 268, bushing 272, thrust bearing 278, first threaded fastener 280, plurality of washers 282 and second threaded fastener 286 are the same as, or similar to the transit belt bracket 34, clamp 36, pivot bolt 36, bushing 72, thrust bearing 78, first threaded fastener 80, washers 82 and second threaded fastener 86 illustrated in FIG. 1 and described above. The clamp 232 includes a first portion 238 that may be configured in a manner similar to first portion 32, described above, to engage the first side tube 214. Similarly, the adapter 253 is the same as, or similar to, the adapter 153 illustrated in FIG. 4 and described above. However, it should be appreciated that the various components can be different from those previously illustrated and described.

Referring again to FIG. 6, the bracket assembly 210 may be assembled by the following assembly steps. As noted previously, the assembly steps are for illustrative purposes and may be conducted in an order other than specifically recited. First, the pivot journal 268 is inserted into an aperture 270 of the bushing 272 until a flange 274 of the bushing 272 seats against a flange 276 of the pivot journal 268. In a next step, the assembled combination of the pivot journal 268 and the bushing 272 are inserted through a first aperture 258a in a first segment 252 of the pivot 232 such that the flange 274 of the bushing 272 seats against a second major surface 256b of the first segment 252 of the pivot 232. The pivot 232 further includes a second segment 254, illustrated as a loop similar to second segment 54, though other structures providing the same functionality may used. The second segment 254 may be fixed or pivotally mounted to the first segment 252 as desired. In the assembled position, the bushing 272 extends through the first aperture 258a and the pivot 232 is rotatably moveable about the bushing 272. In a next step, the thrust bearing 278 is seated against a first major surface 256a of the first segment 252 of the pivot 232. In this assembled position, the bushing 272 extends through the thrust bearing 278.

The assembled combination of the pivot journal 268, bushing 272, pivot 232 and thrust bearing 278 define a common assembly axis, B. These assembled components are inserted through an aperture 250 in a second portion 240 of the clamp 236 such that the bushing 272 seats within the aperture 250 and the thrust bearing 278 seats against a second major surface 248b of the second portion 240 of the clamp 236. Once the assembled combination is seated against the second portion 240 of the clamp 236, the first threaded fastener 280 and washer 282 are inserted into a threaded aperture 283 in the pivot journal 268 and tightened such as to fix the assembly together. In an assembled condition, the pivot 232 is rotatably moveable about the bushing 272.

Referring again to FIG. 6 in a next step, the adapter 253 is positioned such that a shoulder 271 contacts the second major surface 256b of the pivot 232. In this position, a projection 273 seats within a second aperture 258b that is axially aligned with a threaded aperture 275 in the pivot 232. Next, the belt bracket 234 is positioned such that an aperture 266 mates with a projection 284 extending from one end of the adapter 253. Once the belt bracket 234 mates with the projection 284, the second threaded fastener 286 is inserted through the washer 282 and into the threaded aperture 275 in the pivot 232 and tightened such as to fix the belt bracket 234 to the prior assembly. In one variation, another fastener 280 and washer 282 (shown at inset) may be fastened to the opposite side of the adapter 253. In this case, the thrust washer 278 may have a thickness sufficient to permit the pivot 232 to rotate without interference. In yet another variation, the adapter 253 may fixed to the pivot 232, by welding, adhesives, or an upset or peened connection of the projection 273 to the second aperture 258b. In an assembled condition, the belt bracket 234 is rotatably moveable about the projection 284. Once the bracket assembly 210 is completely assembled, it should be evident that the pivot 232 is rotatably moveable about either the axis B and/or the first aperture 258a relative to the clamp 236 and the belt bracket 234 is rotatably moveable about the axis A and/or the second aperture 258b. By having separate axes of rotation, such as axes A and B, alignment of the pivot 232 and the belt bracket 234 can be easily achieved.

Referring again to FIG. 5, assembled bracket assemblies 210 are fastened to the first and second side tubes 214 and 216 as described above. Once the wheelchair is positioned within the vehicle, the tie-down assemblies 224 can be connected to the pivots 232 and the lap belts 235 can be connected to the belt brackets 234.

In operation, the bracket assemblies 210 transfer of the majority of the impact load from the lap belts 226, through the pivots 232, to the vehicle mounted tie-down assemblies 224, thereby providing that the forces and loads are not substantially introduced to the wheelchair frame and other wheelchair structural components.

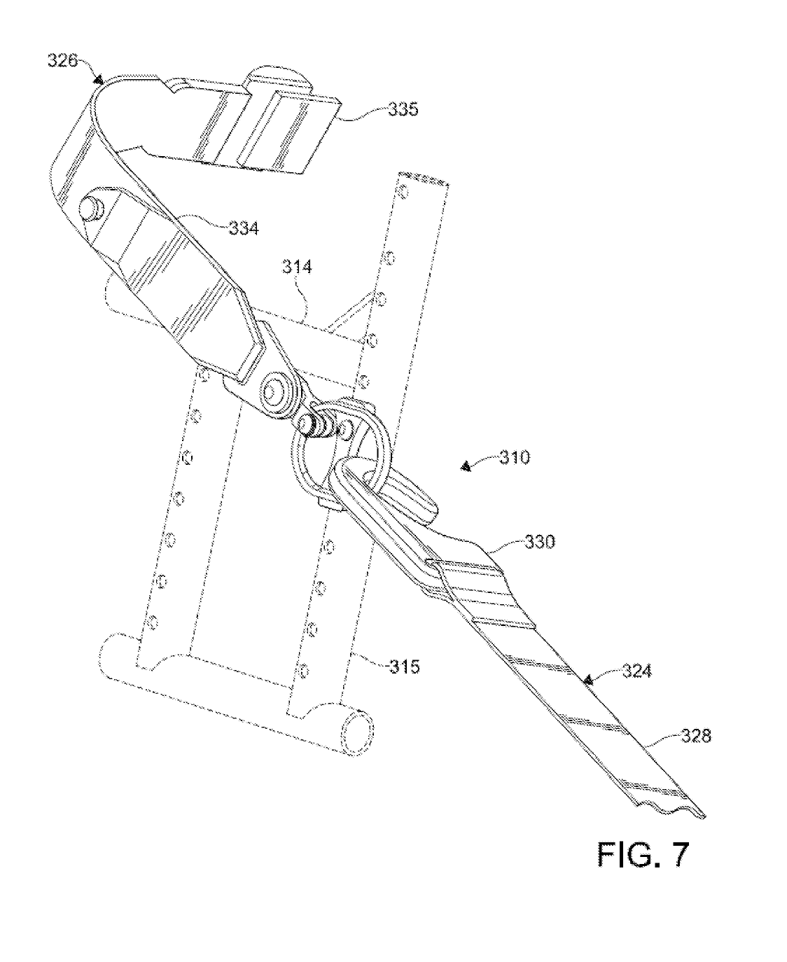

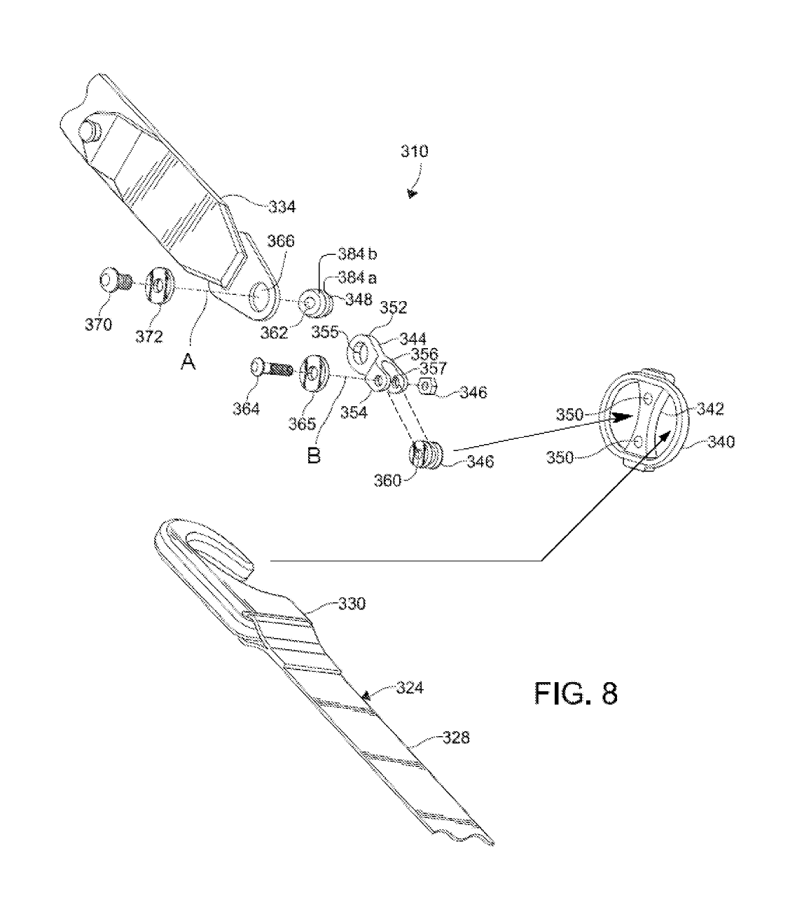

While the embodiments of the bracket assemblies shown in FIGS. 1-6 illustrate the attachment of the various components to the wheelchair frame via a clamp, it should be appreciated that in other embodiments, tie-down assemblies and lap belt assemblies can be connected together using other structures. Referring now to FIGS. 7 and 8, a fourth embodiment of a bracket assembly is shown generally at 310. Generally, the bracket assembly 310 differs from the bracket assemblies shown in FIGS. 1-6 in that the tie-down assemblies and the lap belt assemblies are connected to a transit loop, which in turn is connected to a portion of a wheel chair frame.

Referring now to FIG. 7, the bracket assembly 310 is configured for attachment to a portion of a first down tube 315. For purposes of clarity, only the bracket assembly 310 connected to the first down tube 315 is illustrated. However, it should be appreciated that in practice, another bracket assembly 310 is connected to a second down tube (not shown). While the embodiment illustrated in FIG. 7 illustrates the bracket assembly 310 connected to the first down tube 315, in other embodiments the bracket assembly 310 can be connected to other portions of the wheelchair frame, such as the non-limiting example of a first side tube 314.

Referring again to FIG. 7, a tie-down assembly 324 includes a tie-down strap 328 attached to a connector 330 and a lap belt assembly 326 includes a belt bracket 334 connected to a lap belt 335. In the illustrated embodiment, the tie-down assembly 324 and the lab belt assembly 326 are the same as, or similar to, the tie-down assembly 24 and the lap belt assembly 26 illustrated in FIG. 1 and described above. In other embodiments, the tie-down assembly strap 324 and the lap belt assembly 326 can be different from the tie-down assembly 24 and the lap belt assembly 26.

Referring now to FIG. 8, an exploded view of the bracket assembly 310 is illustrated. The bracket assembly 310 includes a loop 340, a loop bracket 342, a pivot attachment 344, a pivot spool 346 and an adapter 348. The loop 340 is configured to provide connection points for the connector 330 and for the belt bracket 334. In the illustrated embodiment, the loop 340 is configured as a ring having a generally oval shape. Alternatively, the loop 340 can be configured as other structures having other cross-sectional shapes, such as the non-limiting example of a ring having a circular shape or a D-shaped shape, sufficient to provide connection points for the connector 330 and for the belt bracket 334.

The loop 340 is attached to the loop bracket 342. The loop bracket 342 is configured to support the loop 340 and further configured to mount the loop 340 to a portion of the wheelchair frame. In the illustrated embodiment, the loop 340 is attached to the loop bracket 342 by welding. However, in other embodiments, the loop 340 can be attached to the loop bracket 342 by other methods, including mechanical fasteners and adhesives. In still other embodiments, the loop 340 and the loop bracket 342 can be formed such as to be single unitary structure. In yet another variation of the embodiment of FIGS. 7 and 8, the loop 340 may be trapped in the grooves of the loop bracket 342 and held between the loop bracket 342 and the first down tube 315 and not connected to the loop bracket 342 by welding or fasteners.

As shown in FIG. 8, the loop bracket 342 includes a plurality of apertures 350. The apertures 350 are configured to receive fasteners that fasten the loop bracket 342 to the wheel chair frame. Any desired quantity and type of fasteners can be used. The pivot attachment 344 includes an eyelet portion 352 and a saddle portion 354. The eyelet portion 352 includes an aperture 355. The saddle portion 354 includes opposing arms 356, each having an aperture 357. The pivot spool 346 is configured for placement between the opposing arms 356 of the saddle portion 354 of the pivot attachment 344. The pivot spool 346 includes an aperture 360 that extends through the pivot spool 346. A projection 384a, extending from the adapter 348, seats within and is connected to the aperture 355 of the eyelet portion 352 of the pivot attachment 344. In the illustrated embodiment, the adapter 348 is connected to the pivot attachment 344 by welding, however it should be appreciated that in other embodiments, the adapter 348 can be connected to the pivot attachment 344 by other structures, devices or methods. The adapter 348 includes a threaded aperture 362.

As will be explained in more detail below, in an assembled condition, the pivot attachment 344, pivot spool 346 and the adapter 348 are configured to allow a slidable connection between the belt bracket 334 and the loop 340. However, it should be appreciated that in other embodiments, other structures, mechanisms and devices can be used to allow a slidable connection between the belt bracket 334 and the loop 340.

Referring again to FIGS. 7 and 8, the bracket assembly 310 may be assembled by the following assembly steps. As noted previously, the assembly steps are for illustrative purposes and may be conducted in an order other than specifically recited. First, the loop bracket 342, having the attached loop 340, is attached to a portion of the wheelchair frame as described above. Next, the pivot attachment 344, having the attached adapter 348, is positioned such that the opposing arms 356 of the saddle portion 354 engage a portion of the loop 340 such that the opposing arms 356 extend beyond the engaged portion of the loop 340. In a next step, the pivot spool 346 is positioned between the opposing arms 356 such that the aperture 360 of the pivot spool 346 aligns with the apertures 357 in the opposing arms 356. The pivot attachment 344 and the pivot spool 346 are fixed together in an engaged position with the loop 340 as a first fastener 364 and first washer 365 engage the apertures 357 in the opposing arms 356 and the aperture 360 of the pivot spool 346. The first fastener 364 connects to a first fastener nut 368 positioned on the opposing side of the saddle portion 354 of the pivot attachment 344. In this assembled position, the pivot attachment 344 is slidably attached to the loop 340. Alternatively, the pivot spool 346 may also be permitted to rotate about the first fastener 364.

Referring again to FIG. 8, in a next step the belt bracket 334 is positioned such that an aperture 366 mates with a projection 384b extending from the adapter 348. Once the belt bracket 334 mates with the projection 384b, a second threaded fastener 370 and second washer 372 are inserted into the threaded aperture 362 in the adapter 348 and tightened such as to fix the belt bracket 334 to the prior assembly. In an assembled condition, the belt bracket 334 is rotatably moveable about the projection 384b. In a final step, the connector 330 is slidably engaged with the loop 340 such that the tie-down strap 328 is firmly connected. Once the bracket assembly 310 is completely assembled, it should be evident that the belt bracket 334 and the tie-down strap 328 are slidably attached to the loop 340. In this manner, alignment of the belt bracket 334 and the tie-down strap 328 can be easily achieved.

In operation, the bracket assemblies 310 transfer the majority of the impact load from the lap belts 326 to the vehicle mounted tie-down assemblies 324 as described above, thereby providing that the incurred forces and loads are not substantially introduced to the wheelchair frame and other wheelchair structural components.

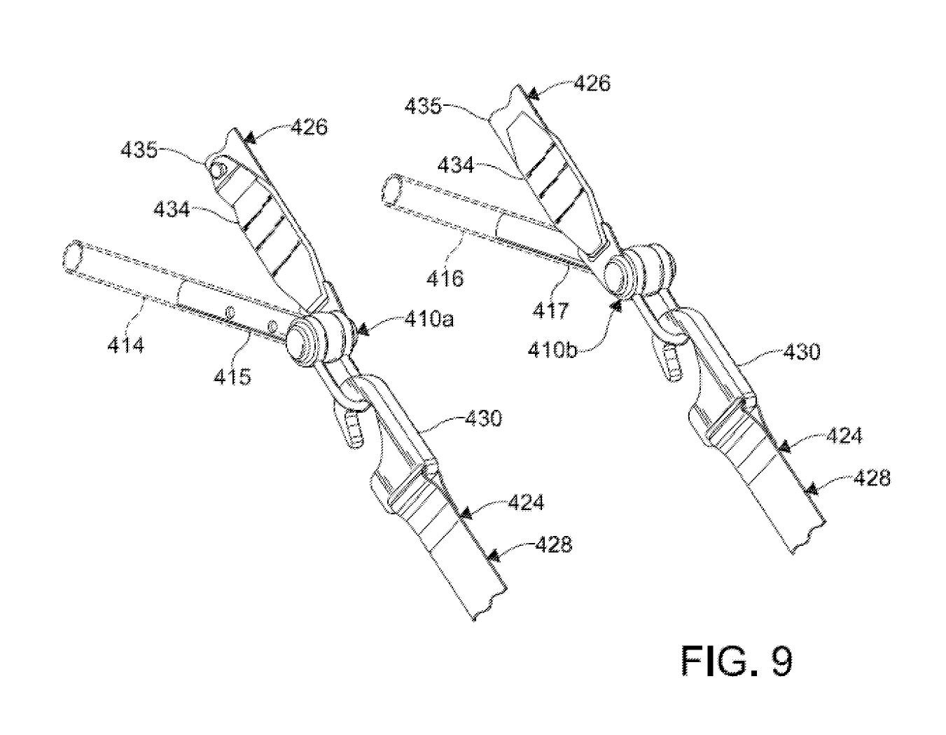

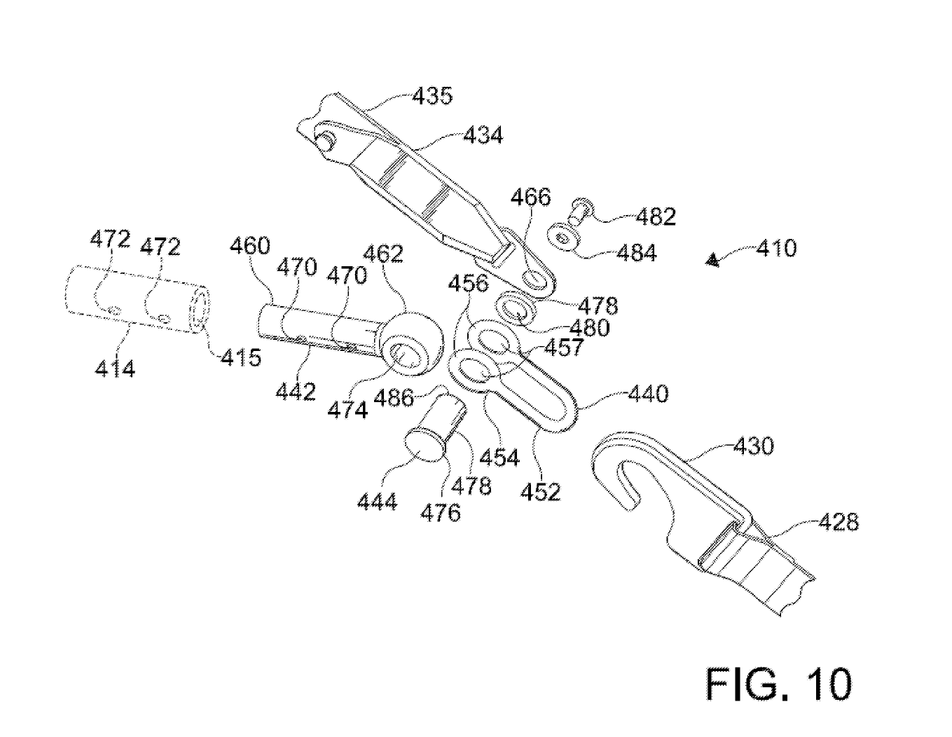

While the embodiments illustrated in FIGS. 1-8 show the bracket assembly attached to a portion of the wheelchair frame via a clamp, it should be appreciated that a bracket assembly can be connected to the wheelchair in other manners. Referring now to FIGS. 9 and 10, a fifth embodiment of a bracket assembly is illustrated generally at 410 (with opposing bracket assemblies shown at 410a and 410b). Generally, the bracket assemblies 410 differ from the bracket assemblies shown in FIGS. 1-8 in that a loop is connected to the wheelchair frame by inserting a loop mount into the interior space of a tube forming a portion of the wheelchair frame and subsequently connecting the loop to the inserted loop mount.

Referring now to FIG. 9, a first bracket assembly 410a is configured for attachment to an interior portion 415 of a first side tube 414. Similarly, a second bracket assembly 410b is configured for attachment to an interior portion 417 of a second side tube 416. While the embodiment illustrated in FIG. 9 illustrates the bracket assemblies 410a and 410b as being connected to the first and second side tubes 414 and 416, in other embodiments the bracket assemblies 410a and 410b can be connected to the interior portions of other tubes forming portions of the wheelchair frame. Each of the tie-down assemblies 424 includes a tie-down strap 428 attached to a connector 430 and each of the lap belt assemblies 426 includes a belt bracket 434 connected to a lap belt 435. In the illustrated embodiment, the tie-down assemblies 424 and lap belt assemblies 426 are the same as, or similar to, the tie-down assemblies 24 and the lap belt assemblies 26 illustrated in FIG. 1 and described above. In other embodiments, the tie-down assemblies 424 and the lap belt assemblies 26 can be different from the tie-down assemblies 24 and lap belt assemblies 26.

Referring now to FIG. 10, an exploded view of the bracket assembly 410 is illustrated. The bracket assembly 410 includes a loop 440, a loop mount 442, a pivot 444 and various assembly hardware. The loop 440 is configured to provide a connection point for the connector 430 and for the belt bracket 434. The loop 440 includes a loop portion 452 and a saddle portion 454. The loop portion 452 is configured as a ring having a generally elongated semi-circular shape. Alternatively, the loop portion 452 can be configured as other structures having other shapes, such as the non-limiting example of a ring having a generally circular shape, sufficient to provide connection points for the connector 430 and for the belt bracket 434. The saddle portion 454 includes opposing arms 456, each having an aperture 457.

Referring again to FIG. 10, the loop mount 442 is configured to connect the loop 440 with an interior portion of the wheel chair frame (shown as the interior portion 415 of first side tube 414). The loop mount 442 includes a first segment 460 and a second segment 462. The first segment 460 is configured for insertion into the interior portion 415 of the tube 414. Accordingly, the first segment 460 has an outer diameter that approximates or can be a slip fit within the inner diameter of the tube 414. The first segment 460 includes a plurality of apertures 470. The apertures 470 are configured to align with a plurality of mating apertures 472 in the tube 414. The second segment 462 of the loop mount 442 is configured for positioning between the opposing arms 456 of the saddle portion 454 of the transit loop 440. The second segment 462 includes an aperture 474. The pivot 444 is formed with a flange 476 and an extension segment 478 extending from the flange 476. The extension segment 478 has an outer diameter that approximates the inner diameter of the apertures 457 in the opposing arms 456 of the loop 440.

Referring again to FIGS. 9 and 10, the bracket assembly 410 may be assembled by the following assembly steps. As noted previously, the assembly steps are for illustrative purposes and may be conducted in an order other than specifically recited. First, the second segment 462 of the loop mount 442 is positioned between the opposing arms 456 of the saddle portion 454 of the loop 440. Next, the extension segment 478 of the pivot 444 is inserted through apertures 457 in both arms 456 of the loop 440 and through the aperture 474 in the second segment 462 of the loop mount 442, such that the flange 476 of the pivot 444 seats against the outside surface of the first arm 456 of the loop 440.

In a next step, a thrust bearing 478 is seated against an outside surface of the second arm 456 such that an aperture 480 within the thrust bearing 478 receives the extension segment 478 of the pivot 444. In this assembled position, the extension segment 478 of the pivot extends through the aperture 480 in the thrust bearing 478. Once the thrust bearing 478 is positioned, the belt bracket 434 is positioned such that an aperture 466 in the belt bracket 434 is seated over extension segment 478 of the pivot 444. The pivot 444, loop mount 442, the loop 440, thrust bearing 478 and the belt bracket 434 are fixed together in an engaged position as a first fastener 482 and first washer 484 engage a threaded aperture 486 within the pivot 444. In this position, the loop 440 is rotatably mounted to the pivot 444 and the belt bracket 434 is rotatably mounted to the extension segment 478 of the pivot 444.

Once the pivot 444, loop mount 442, loop 440, thrust bearing 478 and the belt bracket 434 are fixed together, the first segment 460 of the loop mount 442 is inserted into the interior 415 of the tube 414. The loop mount 442 is retained in the tube 414 through the use of fasteners (not shown) extending through the apertures 472 in the tube 414 and into the apertures 470 in the loop mount 442. In a final step, the connector 430 is engaged with the loop 440 such that the tie-down strap 428 is firmly connected with the loop 440. Once the bracket assembly 410 is completely assembled, it should be evident that the belt bracket 434 and the tie-down strap 428 are attached to the loop 440. In operation, the bracket assemblies 410 transfer of the majority of the impact load from the lap belts 426 to the vehicle mounted tie-down assemblies 424 as described above, thereby providing that the forces and loads are not substantially introduced to the wheelchair frame and other wheelchair structural components.

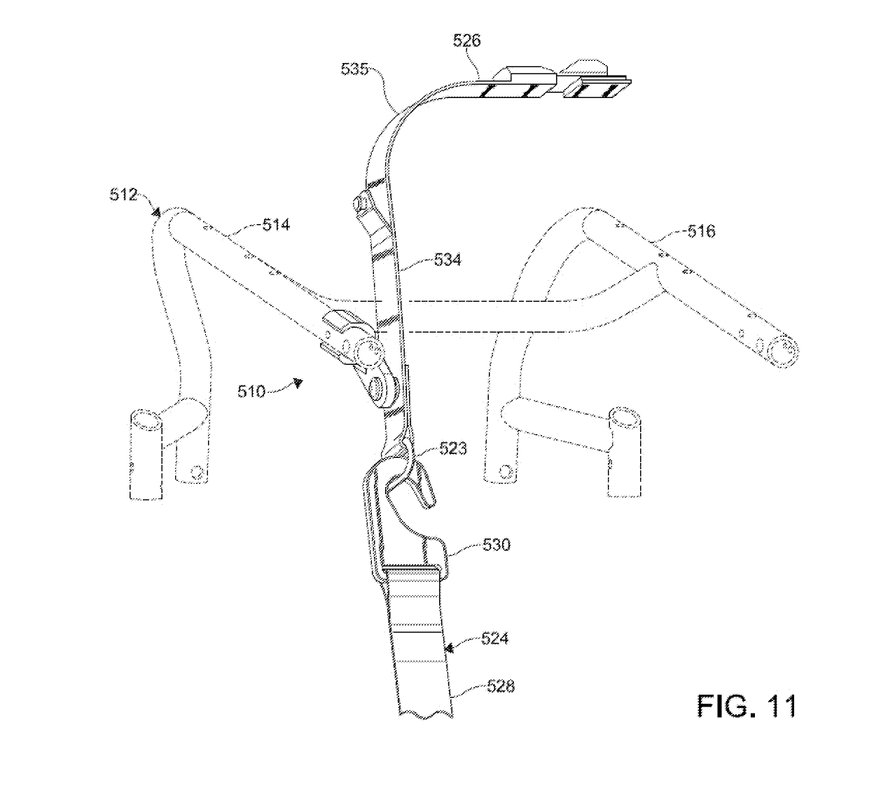

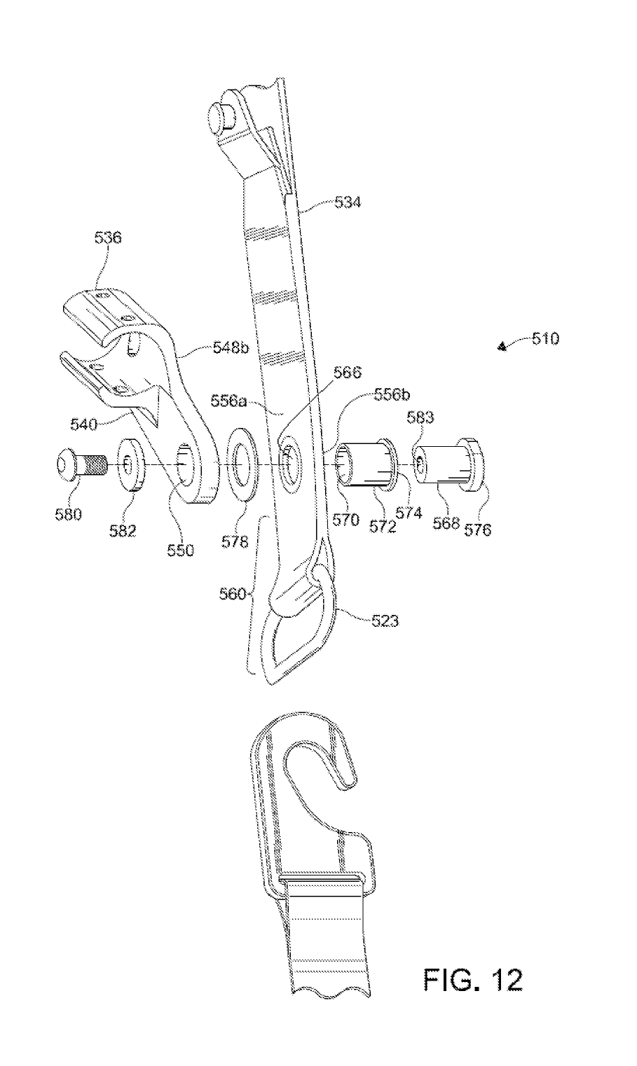

While the embodiments of the bracket assemblies shown in FIGS. 1-10 illustrate the assembly of the various components through rigidly assembled structures, it should be appreciated that in other embodiments, a bracket assembly incorporating a flexible attachment loop can be used. Referring now to FIGS. 11 and 12, a sixth embodiment of a bracket assembly is shown generally at 510. Generally, the bracket assembly 510 differs from previous bracket assemblies in that the belt bracket is flexibly connected to a tie-down assembly such that the resulting bracket assembly can flex or bend out of the way when contacting an outside object.

Referring now to FIG. 11, the bracket assembly 510 is configured for attachment to a portion of the first side tube 514 of a frame 512. For purposes of clarity, only the bracket assembly connected to the first side tube 514 is illustrated. However, it should be appreciated that in practice, another bracket assembly 510 is connected to a second side tube 516. In the illustrated embodiment, the frame 512 is the same as, or similar to, the frame 12 illustrated in FIG. 1 and described above. Alternatively, the frame 512 can be different from the frame 12. A tie-down assembly 524 includes a tie-down strap 528 attached to a connector 530 and a lap belt assembly 526 includes a belt bracket 534 connected to a lap belt 535. In the illustrated embodiment, the tie-down assembly 524 and the lap belt 535 are the same as, or similar to, the tie-down assembly 24 and the lap belt 35 illustrated in FIG. 1 and described above. In other embodiments, the tie-down strap assembly 524 and the lap belt 535 can be different from the tie-down assembly 24 and the lap belt 35.

Referring now to FIG. 12, a clamp 536, pivot bolt 568, bushing 572, thrust bearing 578, threaded fastener 580 and washer 582 are illustrated. In the illustrated embodiment, the clamp 536, pivot bolt 568, bushing 572, thrust bearing 578, threaded fastener 580 and washer 582 are the same as, or similar to the clamp 36, pivot journal 68, bushing 72, thrust bearing 78, threaded fastener 80 and washer 82 illustrated in FIG. 2 and described above. However, it should be appreciated that these components can be different. The belt bracket 534 includes a first portion 560 and an aperture 566. The first portion 560 of the belt bracket 534 is formed so as to be flexible. In the illustrated embodiment, the first portion 560 is formed from a fabric-based material, such as for example the same material forming the tie-down strap 528. However, it should be appreciated that in other embodiments, the first portion 560 of the belt bracket 534 can be formed from other materials, such as the non-limiting examples of webbing, wire or cables, sufficient to be flexible. The end of the first portion 560 of the belt bracket 534 includes a loop 523. The loop 523 is configured to receive the connector 530 and will be discussed in more detail below.

Referring again to FIG. 12, the bracket assembly 510 may be assembled by the following assembly steps. As noted previously, the assembly steps are for illustrative purposes and may be conducted in an order other than specifically recited. First, the pivot bolt 568 is inserted into an aperture 570 of the bushing 572 until a flange 574 of the bushing 572 seats against a flange 576 of the pivot bolt 568. In a next step, the assembled combination of the pivot bolt 568 and the bushing 572 are inserted through the aperture 566 in the first portion 560 of the belt bracket 534 such that the flange 574 of the bushing 572 seats against a second surface 556b of the belt bracket 534. In this assembled position, the bushing 572 extends through the aperture 566 and the belt bracket 568 is rotatably moveable about the bushing 572. In a next step, the thrust bearing 578 is seated against a first surface 256a of the of the belt bracket 534. In this assembled position, the bushing 572 extends through the thrust bearing 578.

The assembled combination of the pivot bolt 568, bushing 572, belt bracket 534 and thrust bearing 578 are inserted through an aperture 550 in a second portion 540 of the clamp 536 such that the bushing 572 seats within the aperture 550 and the thrust bearing 578 seats against a second major surface 548b of the second portion 540 of the clamp 536. Once the assembled combination is seated against the second portion 540 of the clamp 536, the threaded fastener 580 and washer 582 are inserted into a threaded aperture 583 in the pivot bolt 568 and tightened such as to fix the assembly together. In an assembled condition, the belt bracket 534 is rotatably moveable about the bushing 572.

Referring again to FIG. 11, the assembled bracket assembly 510 is fastened to the first side tube 514 as described above. Once the wheelchair is positioned within the vehicle, the tie-down assemblies 524 can be connected to the loop 523 and the lap belts 535 can be connected to the belt brackets 534.

In operation, the bracket assemblies 510 transfer of the majority of the impact load from the lap belts 526 to the vehicle mounted tie-down assemblies 524 as described above, thereby providing that the forces and loads are not substantially introduced to the wheelchair frame and other wheelchair structural components.

The principles and mode of operation of the wheelchair transit bracket assembly have been described in its preferred embodiments. However, it should be noted that the wheelchair transit bracket assembly may be practiced otherwise than as specifically illustrated and described without departing from its scope.

What is claimed is:

1. A wheelchair transit bracket assembly comprising:
a mounting structure attached to a portion of a wheelchair frame;
a tie-down assembly being configured to secure the wheelchair to a vehicle during transit;
a pivot attached to the mounting structure, the pivot being rotatable relative to the mounting structure and providing an attachment point for the tie-down assembly; and
a belt bracket attached to the pivot and being rotatable relative to the wheelchair frame, the belt bracket supporting a lap belt thereby forming a lap belt assembly that is configured to secure an occupant to the wheelchair during transit;
wherein the wheelchair transit bracket assembly is configured to transfer loads and forces generated by the wheelchair occupant from the lap belt assembly to the tie-down assembly during one of a braking and an acceleration event without substantially introducing the occupant-generated loads and the forces from the one of the braking and acceleration event to the wheelchair frame.

2. The wheelchair transit bracket assembly of claim 1, wherein the mounting structure is a clamp having a first portion configured for mounting to an outer surface portion of the wheelchair frame and a second portion for rotatably mounting the tie-down relative to the wheelchair frame.

3. The wheelchair transit bracket assembly of claim 1, wherein the mounting structure is a loop mount having a first segment configured for mounting to an inner surface portion of the wheelchair frame and a second segment for rotatably mounting the tie-down relative to the wheelchair frame.

4. The wheelchair transit bracket assembly of claim 2 wherein the second portion includes a first major surface and a second major surface, at least one of the first and second major surfaces supporting the pivot against axial movement relative to the second portion.

5. The wheelchair transit bracket assembly of claim 4 wherein the second portion includes an aperture that supports the pivot for rotation relative to the second portion, and a thrust washer contacts at least one of the first and second major surfaces to support a thrust load from the pivot.

6. The wheelchair transit bracket assembly of claim 4 wherein the pivot and the belt bracket are positioned on the same side of the clamp as the second major surface.

7. The wheelchair transit bracket assembly of claim 4 wherein the pivot includes a second aperture that defines an axis of rotation of the belt bracket that is offset from the axis of rotation of the pivot relative to the second portion.

8. The wheelchair transit bracket assembly of claim 2 wherein the second portion includes a projection that supports the pivot for rotation on one side of the second portion and the belt bracket is supported for rotation on the opposite side, the pivot and the belt bracket having a common rotational axis.

9. The wheelchair transit bracket assembly of claim 3 wherein the loop mount second segment includes an aperture that receives a pivot journal, the pivot journal rotatably supporting a loop that is configured to connect to the tie-down assembly.

10. The wheelchair transit bracket assembly of claim 1 wherein the mounting structure is a loop bracket that mounts to the outer surface of the frame, the pivot is a loop and a pivot attachment having an eyelet portion and a saddle portion that engages the loop, the eyelet portion engages the belt bracket and the tie-down engages the loop.

11. The wheelchair transit bracket assembly of claim 10 wherein the loop bracket and the loop are a single component.

12. The wheelchair transit bracket assembly of claim 11 wherein the loop bracket is connected to a frame down tube.

13. A wheelchair transit bracket assembly comprising:
two clamps configured to be mounted to two spaced-apart wheelchair frame members, each clamp having a first portion that includes at least one arm configured to engage at least a portion of an outer surface of the wheelchair frame member and a second portion for rotatably mounting the tie-down relative to the wheelchair frame member;
two pivots, each pivot attached to the second portion of each clamp, each pivot being rotatable relative to the frame and cooperating to define a generally common pivot axis, each pivot further providing an attachment point for a tie-down assembly, the tie-down assembly being configured to secure the wheelchair to a vehicle during transit; and
a belt bracket attached to each pivot, each belt bracket being rotatable relative to the wheelchair frame member, each of the belt brackets supporting a lap belt portion which cooperate to form a lap belt assembly that is configured to secure an occupant to the wheelchair during transit;
wherein the wheelchair transit bracket assembly is configured to transfer loads and forces generated by the wheelchair occupant from the lap belt assembly to the tie-down assembly during a braking event without substantially introducing the occupant-generated loads and the forces from the braking event to the wheelchair frame.

14. The wheelchair transit bracket assembly of claim 13 wherein each of the clamps has opposing arms, each of the pivots having a first segment and a second segment that is the attachment point, the first segment being pivotally attached to the clamp first portion and the second segment being a loop.

15. The wheelchair transit bracket assembly of claim 14 wherein each of the pivot first segments includes an aperture, each of the clamp second portions having an aperture, and two pivot journals, each pivot journal extending through the pivot first segment aperture and the clamp second portion apertures to provide rotational movement of the pivot relative to the clamp.

16. The wheelchair transit bracket assembly of claim 15 wherein each of the belt brackets includes a first portion that is supported on each of the pivot journals for rotation relative to the wheelchair frame and a second portion that supports the lap belts to form the lap belt assembly.

17. The wheelchair transit bracket assembly of claim 16 wherein each of the pivots includes a projection that supports the belt bracket first portions for rotation relative to the frame.

18. The wheelchair transit bracket assembly of claim 14 wherein one of the two first pivot segments and the two clamp second portions includes a projection and the other of the two first pivot segments and the two clamp second portions each includes an aperture that is supported for relative rotation therebetween by the projections.

19. A wheelchair comprising:
a frame having spaced-apart frame elements;
a seat attached to the frame, the seat configured to receive an occupant;
a plurality of wheels attached to the frame such as to allow the frame to roll;
a plurality of wheelchair transit bracket assemblies connected to a portion of the wheelchair frame, each of the wheelchair transit bracket assemblies having:
a transit clamp that is attached a portion of one of the spaced-apart frame elements;
a pivot attached for rotation relative to the clamp and having a loop for attachment to a tie-down assembly, the tie-down assembly configured to secure the wheelchair to a vehicle during transit; and
a belt bracket pivotally attached to the clamp, the belt bracket supporting a lap belt that cooperates with another lap belt to form a lap belt assembly, the lap belt assembly being configured to secure an occupant to the wheelchair during transit.

20. The wheelchair of claim 19 wherein the spaced-apart frame elements are frame side tubes and the belt bracket and the pivot are attached to the clamp by a common pivot axis.
